(19) United States
(12) Patent Application Publication
(10) Pub. No.: US 2007/0177836 A1
(43) Pub. Date: Aug. 2, 2007

(54) Outer ring of a wheel bearing

(75) Inventors: Peter Niebling, Bad Kissingen (DE); Jens Heim, Bergrheinfeld (DE); Heinrich Hofmann, Schweinfurt (DE); Roland Langer, Schwanfeld (DE); Darius Dlugai, Schweinfurt (DE); Horst Doeppling, Herzogenaurach (DE); Wolfgang Steinberger, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Schweinfurt (DE)

(21) Appl. No.: 10/596,494

(22) PCT Filed: Dec. 6, 2004
(86) PCT No.: PCT/DE04/02677

§ 371 Date: Sep. 22, 2006

(30) Foreign Application Priority Data
Dec. 18, 2003 (DE) 103 59 643.7

(51) Int. Cl. F16C 13/00

(52) U.S. Cl. 384/544

(57) ABSTRACT

The Invention relates to an outer ring of a wheel bearing. Said outer ring comprises a hollow cylindrical section and a flange which protrudes radially outward from said hollow cylindrical section. The flange extends into the section at a concave groove.

### FIELD OF THE INVENTION

The invention relates to an outer ring of a wheel bearing, the outer ring having a hollow cylindrical section and having a flange which leads radially outwards from the hollow cylindrical section, the flange on a concave channel merging into the section.

### BACKGROUND OF THE INVENTION

DE 39 40 395 A1 describes a wheel bearing having an outer ring, rolling bodies and two inner rings, in which the outer ring has a radial flange axially between the end sides and away from the end sides, with which radial flange the wheel bearing is suspended. The wheel bearing is fixed to the wheel carrier axially and radially via the flange. A hollow cylindrical section of the outer ring which adjoins the flange axially is seated in a hole of the carrier, with the result that the outer ring bears against the carrier axially by means of the flange and at least partially radially at least by way of the section. The outer ring is loaded highly in the channel at the transition from the flange to the section. The channel is therefore usually rounded with a radius in order to avoid notch fractures. However, the stresses which prevail in the channel are still excessively high, especially as the outer ring also bears against the carrier via the channel and, as a result, additional stresses are built up under load in the flange.

### SUMMARY OF THE INVENTION

The object of the invention is therefore to provide an outer ring for a wheel bearing unit, the installation of which onto or into a wheel carrier or the like avoids the above-mentioned disadvantages.

This object is solved according to the subject matter of claim 1.

The flange preferably bears axially against the wheel carrier only in sections. Here, the outer ring bears against the wheel carrier radially with a hollow cylindrical section and axially with the flange in such a way that the wheel carrier does not bear against the concave channel, at which the flange merges into the section. Here, as viewed in a longitudinal section through the outer ring along the rotational axis of the outer ring, the concave contour of the channel merges, for example, into an circular ring face of the flange at a first transition and, for example, into a cylindrical circumferential surface of the section at a second transition. As an alternative, the first and the second transitions end, for example, in each case in an annular groove which is shaped in the manner of an undercut in the flange and in the section, respectively. Here, it is particularly significant that a perpendicular spacing between an imaginary axial extension of the circumferential surface of the flange and the first transition is smaller than a spacing which is parallel to the rotational axis between an imaginary radial extension of the circumferential surface and the second transition.

It has been proven in tests that the maximum notch stress in the channel can be reduced by approximately 30% by this design of the contour. Here, the channel is advantageously described by at least two radii which follow one another between the transitions, at least one first radius merging radially into the flange at the transition and at least one second radius merging axially into the first section at the transition. In the longitudinal section in the direction of the transitions, the radii are either separated from one another by a straight line or preferably merge into one another between the flange and the section.

The flange is configured here axially between the end sides of the flange and axially spaced apart here with respect to the end sides, or is fastened to the outer ring. Here, the wheel bearing is suspended on the wheel carrier or the like by means of the flange or is supported at least partially radially in the wheel carrier.

The outer ring is supported at least in sections in the wheel carrier at least radially with respect to the rotational axis in such a way that the flange which is formed axially on the end side of the outer ring bears axially against the wheel carrier and radially against the outer ring, without the carrier being in contact with the channel. Additional stresses in the channel as a result of the influence of sharp edges of the carrier are also avoided by a sufficiently dimensioned chamfer on the hole.

The section of the outer ring, on which raceways for the rows are formed at least partially, is supported radially completely in the wheel carrier. As a result, the entire wheel bearing is usually surrounded by the wheel carrier. The wheel bearing is secured axially in the hole with respect to the carrier via the flange, as the flange is fastened to the flange with suitable means. Axial movement of the outer ring during driving operation is avoided. Moreover, from the outset the channel is unloaded at the transition from the flange to the outer ring, as the outer ring is supported radially in the carrier under load.

Wheel bearings in this context are to be understood as all single row, double row and multiple row wheel bearings having rollers and/or balls as rolling bodies, and having one or more single part or multiple part inner rings, which are configured in a very wide variety of arrangements, such as in a radial or angular contact ball bearing arrangement or in a radial or angular contact roller bearing arrangement. As an alternative, one or all of the inner raceways is/are not formed on one or a plurality of inner rings but is/are formed directly on a hub which is arranged in the wheel bearing.

Before installation of the wheel bearing in the wheel carrier, the hub of a wheel bearing module for a driven or nondriven wheel is fixed in the wheel bearing, for example by a flange rim on the hub. Here, the flange rim engages behind the bearing arrangement in such a way that the hub is fixed on the wheel bearing such that it cannot be separated from the wheel bearing. As an alternative to this, the hub or a bolt, with which the wheel is mounted in the wheel bearing such that it can rotate with respect to the wheel carrier, is inserted only when the wheel bearing is fixed on the carrier.

A further embodiment of the invention provides for the outer ring to be relatively thin walled and therefore to be elastic in comparison with the rigid housing which surrounds the hole. On account of the thin cross sections of the wall, before assembly the outer ring has deviations from ideal roundness on the outside and inside, in particular at the raceways, at least on the section with which the outer ring is pressed into the hole, as viewed in cross section transversely with respect to the rotational axis. These deviations are substantially greater than the deviations from ideal roundness in the hole, as the roundness of the hole is accurate as a result of material removing machining. The roundnesses at the raceway which are ultimately a requirement of the function are produced on the outer ring only when the outer ring is pressed into the hole.

The diameter of the outer ring is constricted by being pressed in and the outer ring is adapted to the roundnesses of the hole. This elastic shape change is transmitted to the geometry of the raceways, with the result that the diameter of the raceways in the contact zones meets the necessary requirements with regard to acceptable deviations from ideal roundness. Moreover, the elastic shape change is also advantageous, inter alia, for the necessary freedom from play of the wheel bearing when the wheel bearing is assembled complete as a unit. The hole in the wheel carrier which is rigid in comparison with the outer ring has substantially the initial geometry before the wheel bearing is pressed in. The outer ring is seated fixedly in the carrier, as a result of which creaking noises are avoided.

The thin walled outer ring is preferably configured in one piece with the flange, but the flange can also be fastened to the outer ring by welding or by a force transmitting and/or form fitting seat. One embodiment of the invention provides for the outer ring to be made from formed material. The design of the outer ring with all its shaped elements is accordingly also produced by forming. Cutting or material removing machining is restricted to only a very small amount of the machining in comparison with the chipless machining. Only excess material, edges, burrs and the like are therefore removed from the shaped part by cutting or punching. If appropriate, only the raceways are subsequently machined in a material removing manner by precision machining such as grinding, lapping or polishing. Cold forming is to be understood as all the forming processes, in which the contour of the hollow outer ring can be manufactured by stretching or upset forging, expansion or contraction, and the shape of the starting material can undergo plastic deformation in the process without material being cut. Processes of this type are, for example, drawing, deep drawing, rolling, pressing and combinations of the above-mentioned processes.

Tubes and metal sheets are provided, for example, as blanks for the manufacture of the outer rings. A blank comprising a tube is machined to form the finished outer ring by expansion, rolling, contracting, upset forging and the folding over of edges. Outer rings which are manufactured from a metal sheet are manufactured by drawing and further above-mentioned processes or combinations of the latter. In this case, one embodiment of the invention provides for the flange to be exactly as wide, axially from the end side of the outer ring as far as the wheel carrier, against which the flange bears, as the starting material of the metal sheet was thick before the outer ring was manufactured. Preferred materials are cold formable bearing materials, such as 100Cr6 or else all suitable deep drawing steels.

The outer ring is distinguished by a low weight, as a starting material having a small wall thickness or small sheet thickness is used. The thickness of the starting material preferably lies in the range from 2.4 to 5 mm. The overall proportion of the wheel bearing unit in the weight of the unsprung masses is reduced by way of the thin walled outer ring which is manufactured by removing material or without cutting.

The wheel bearing for mounting driven and/or nondriven wheels on vehicles is installed with the outer ring in the wheel carrier in such a way that the flange of the outer ring points toward the vehicle or away from the vehicle. As an alternative, in wheel bearings with which driven wheels are mounted, either the flange of the outer ring bears against the side of the wheel carrier which faces the wheel flange, or the flange bears against a side of the wheel carrier which faces away from the wheel flange.

The flange is preferably fastened to the wheel carrier with bolts which, for example, are screwed or pressed into the wheel carrier. Other fastening elements are conceivable, such as clamps or the like which engage axially behind the flange at least one fastening edge on a side of the flange which faces away from the wheel carrier. As an alternative, bolts are provided which are fastened to the wheel carrier by welding or screwing and onto which in each case a nut is screwed and prestressed axially against the flange. The bolts engage through axial recesses on the flange.

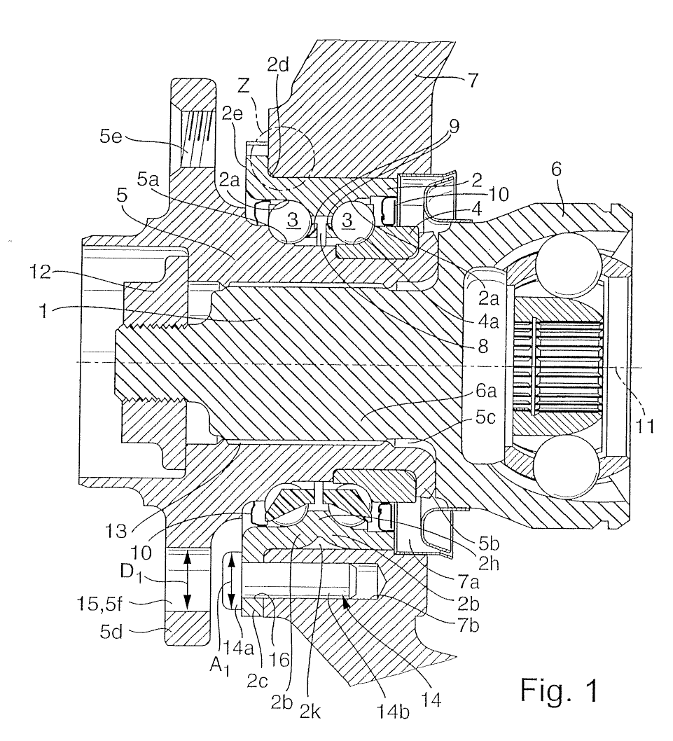

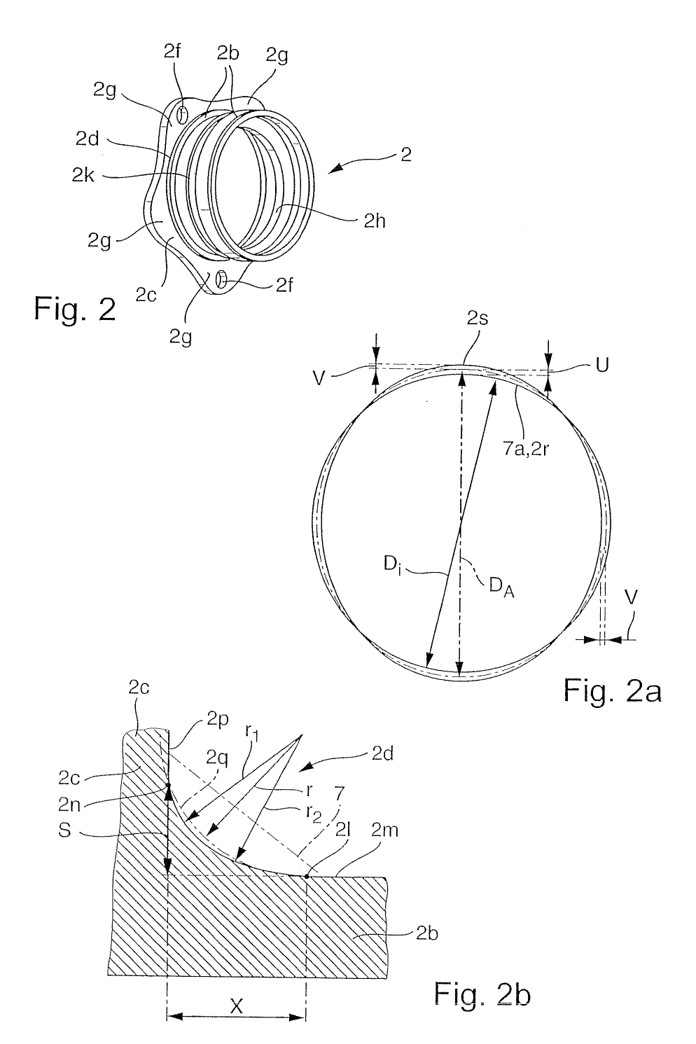

Further embodiments and realizations of the invention are described in greater detail in FIGS. 1 to 2-2b.

### DETAILED DESCRIPTION OF THE DRAWINGS

FIG. 1 shows a wheel bearing module 1 in a longitudinal section along a rotational axis 11. The wheel bearing module is provided with an outer ring 2, with two rows of rolling bodies 3, with an inner ring 4, with a hub 5 and with an articulation bell 6. The structural unit of the wheel bearing module which is preassembled from the individual parts 2, 3, 4, 5, 6 is seated in a wheel carrier 7.

The wheel bearing 8 comprising the outer ring 2, the rolling bodies 3, in the form of balls in this example, cages 9, seals 10, the inner ring 4 and the hub 5 is preassembled such that it is selfholding. To this end, the rolling bodies 3 and the inner ring 4 are held in the outer ring 2 by means of the hub 5. Here, a row of the rolling bodies 3 is supported on a raceway 2a of the outer ring 2 and on a raceway 5a which is formed directly on the hub 5. The other row of the rolling bodies 3 is arranged between a further raceway 2a and a raceway 4a of the inner ring 4. The wheel bearing 8 is prestressed without play on the hub 5 by means of a flange rim 5b via the inner ring 4 and the outer ring 2, at least when the wheel bearing 8 is mounted in the wheel carrier 7. The hub 5 is fixed unreleasably to the wheel bearing 8 via the flange rim 5b.

The hub 5 is in essence of a rotationally symmetrical configuration about a rotational axis 11 and has an axial through hole 5c. A stub 6a on the articulation bell 6 engages through the through hole 5c axially. The articulation bell 6 is secured axially on the hub 5 via a nut 12. A radially outwardly pointing wheel flange 5d is formed on the hub 5. A connection which is rotationally fixed about the rotational axis 11 between the articulation bell 6 and the wheel flange 5d is produced via tooth profiles 13 on the stub 6a and on the hub 5.

Axial holes 5e are formed on the wheel flange 5d, into which axial holes 5e wheel bolts (not shown) engage for fastening a vehicle wheel. Furthermore, the wheel flange 5d has axial recesses 5f which lie axially opposite a flange 2c at least once per revolution of the wheel flange 5d about the rotational axis 11, in such a way that the wheel flange 5d does not cover the fastening element 14 axially on account of the recesses 5f. The diameter D₁ of the recess 5f which is configured as an axial through hole 15 is greater than the greatest radial dimension A₁ of the head 14a.

The outer ring 2 is formed from two hollow cylindrical sections 2b and the radial flange 2c. The wheel bearing 8 is supported radially in a hole 7a of the wheel carrier 7 via the sections 2b. At one of the sections 2b, the outer ring 2 merges radially into the flange 2c via a channel 2d. The flange 2c bears axially on the outside against the wheel carrier 7, and the fastening elements 14 in the form of bolts engage behind said flange 2c on the side 2e which faces axially away from the wheel carrier 7. The fastening element 14 is prestressed with the head 14a axially fixedly against the flange 2c, as a stem 14b which is fixed on the bolt is fixed axially in a fastening hole 7b of the wheel carrier 7. The fastening elements 14 are optionally pressed or screwed into the fastening holes 7b.

FIG. 2 shows a full view of the outer ring 2. The outer ring 2 is a component which has been manufactured by cold forming and the flange 2c of which has radially protruding sections 2g. The outer recesses 2f are made as axial through holes 16 in three of the sections 2g.

FIG. 2a shows the shape deviations of the outer ring 2 as an individual part in comparison with the inner geometry 2r of the hole 7a. After cold forming, on account of its thin wall, the outer ring 2 has an outer geometry 2s, the diameter D_{A} of which is initially greater than the internal diameter D_{I} of the hole 7a by the excess dimension 2×U. In addition, the outer geometry 2s differs from the inner geometry 2r of the hole 7a by the amount 2×V. After mounting of the outer ring 2 in the hole 7a, the outer ring 2 is constricted to such an extent that the outer geometry 2s corresponds substantially to the diameter D_{I} and the inner geometry 2r.

The outer ring 2 has a radial shoulder 2h. The radial shoulder 2h is arranged between the raceways 2a, the raceways 2a being configured at least partially on the radial shoulder 2h. An annular groove 2k is made in the outer ring 2 radially from the outside. The annular groove 2k is produced firstly by the displacement of material from the outer ring 2 for forming the radial shoulder 2h, and secondly imparts a certain amount of elasticity to the outer ring 2 in the region of the raceways 2a.

FIG. 2b, an enlarged illustration of the detail Z from FIG. 1, shows the channel 2d in a highly enlarged manner and not to scale. The channel 2d is of concave configuration and merges into a circular cylindrical circumferential surface 2m of the section 2b at a first transition 2l. At the flange 2c, the channel 2d merges into an annular face 2p at the transition 2n. The perpendicular spacing S between the imaginary axial extension of the circumferential surface 2m and the transition 2n is smaller than a spacing X which is parallel to the rotational axis 11 between an imaginary radial extension of the annular face 2p and the transition 2l.

FIG. 2b also shows that the contour of the channel 2d deviates in a longitudinal section through the outer ring 2 from a contour 2q which is shown by dash dotted lines and is described by a radius r. The channel 2d is described in the longitudinal section by the radii r₁ and r₂. The radius r₁ merges into the flange 2 at the transition 2n and the radius r₂ merges axially into the section 2b at the transition 2l. The radii r₁ and r₂ merge into one another between the flange 2c and the section 2b.

The wheel carrier 7 bears axially against the flange 2c and radially against the section 2b in such a way that the wheel carrier 7 and the channel 2d are spaced apart from one another at least as far as the transitions 2l and 2n. The maximum stresses radially below the recesses 2f are approximately a third higher on the contour 2q which is described by the radius r than the stresses in a channel 2c which is described by the radii r₁ and r₂.

### LIST OF DESIGNATIONS

1 Wheel bearing module
2 Outer ring
2a Raceway
2b Section
2c Flange
2d Channel
2e Side
2f Recess
2g Section
2h Radial shoulder
2k Annular groove
2l Transition
2m Circumferential surface
2n Transition
2p Face
2q Contour
2r Inner geometry
2s Outer geometry
3 Rolling body
4 Inner ring
4a Raceway
5 Hub
5a Raceway
5b Flange rim
5c Through hole
5d Radial flange
5e Holes
5f Recess
6 Articulation bell
6a Stub
7 Wheel support
7a Hole
7b Hole
8 Wheel bearing
9 Cages
10 Seal
11 Rotational axis
12 Nut
13 Tooth profile
14 Fastening element
14a Head
14b Stem
15 Hole
16 Hole

1. An outer ring of a wheel bearing comprising a hollow cylindrical section and a flange which leads radially outwards from the hollow cylindrical section, the flange merging at a concave channel into the section wherein the channel, as viewed in a longitudinal section through the outer ring along the rotational axis of the outer ring, merges into a face of the flange at a first transition and into a circumferential surface on the section at a second transition, and the perpendicular spacing between an imaginary axial extension of the circumferential surface and the first transition being smaller than a spacing which is parallel to the rotational axis between an imaginary radial extension of the face and the second transition.

2. The outer ring as claimed in claim 1, herein the ratio between the perpendicular spacing and the parallel spacing is at least 1:1.5.

3. The outer ring as claimed in claim 1, wherein the channel is described in longitudinal section by radii, at least one first radius merging radially into the flange at the transition and at least one second radius merging axially into the first section at the transition.

4. The outer ring as claimed in claim 14, wherein the first radius and the second radius merge into one another between the flange and the section.

5. The outer ring as claimed in claim 4, wherein the first radius is smaller than the second radius.

6. The outer ring as claimed in claim 1, wherein the ratio between the first radius and the second radius is at least 1:2.5.

7. The outer ring as claimed in claim 1, wherein the outer ring is supported at least in sections in the wheel carrier at least radially with respect to the rotational axis, and the flange which is formed axially on the end side of the outer ring bears axially against the wheel carrier here, the wheel carrier bearing axially against the flange and radially against the circumferential surface in such a way that the wheel carrier and the channel are spaced apart from one another at least as far as the transitions.

8. The wheel bearing as claimed in claim 1, wherein the outer ring with the flange is cold formed in one piece.

9. The wheel bearing as claimed in claim 1, wherein at least one fastening element engages axially behind the flange on a side of the flange which faces axially away from a wheel carrier, and the fastening element bears axially fixedly here against the flange, the fastening element being fixed on the wheel carrier.

10. The wheel bearing as claimed in claim 9, wherein the fastening element is a bolt with a head, the bolt with the head bearing axially against the flange by engaging through a recess of the flange, fastening the flange to the wheel carrier.

11. The wheel bearing as claimed in claim 5, wherein the recesses are open radially to the outside.
